(19) United States
(12) Patent Application Publication
(10) Pub. No.: US 2006/0007676 A1
(43) Pub. Date: Jan. 12, 2006

(54) Flashlight

(76) Inventor: Jerry Song, Taipei City (TW)

Correspondence Address: Jerry Song, P.O. Box 90, Tainan City, 704, TW

(21) Appl. No.: 10/886,694

(22) Filed: Jul. 9, 2004

(51) Int. Cl. F21L 4/00

(52) U.S. Cl. 362/195

(57) ABSTRACT

A flashlight includes a base, a lamp unit, a cover, and a 9V battery. The base has plural through holes, and the lamp unit arranged on the base consists of an electric circuit board, plural LED, a switch and two terminals. The LED and the switch are positioned on the circuit board, and the two terminals are fixed under the lower surface of the circuit board. The cover is closed on the base. A user combines the 9V battery under the base, with its terminals extending through the base and contacting with the terminals of the lamp unit. Then the user turns on the flashlight for shining any location by griping the battery and moving or putting the flashlight at any location to shine it movingly or stationarily. The flashlight can also be used as a decoration, with the battery taken off, and with a hanging chain strung through the cover for wearing.

### BACKGROUND OF THE INVENTION

1. Field of the Invention

This invention relates to a flashlight, particularly to one provided with a base, a lamp unit, a cover and a 9V battery. The base has a through hole, and the lamp unit is secured on the base and consists of an electric circuit board and a plurality of LED and a switch fixed on the circuit board. Two terminals are fixed under the lower surface of the circuit board. The cover is closed over the base and the lamp unit. In using, the 9V battery combined with the lower side of the base, with its terminals extending through the through holes of the base and positioned in the contact condition with the terminals of the circuit board, and a user presses the switch for turning on the lamp unit, with the hand of the user holding the battery securely. Thus the flashlight of the invention can movably be used for shining, or placed at any location stationary for shining constantly that location only. If not used, the 9V battery can be taken off, and a key chain can string through the cover of the flashlight, with the flashlight functioning as a decoration worn on the neck or hung on a wall and convenient to carry around.

2. Description of the Prior Art

Conventional flashlights have been used simply as a shining apparatus, generally consisting of a lamp in a front head and a battery (or batteries) received in a rear portion of the body, and turned on and off by a switch. They are generally stored in a box or a tool case, not so handy for carrying around, so there have been produced some small-sized flashlights possible to hang on a key chain with keys. But this kind of flashlight is also used for shining only, with not so neat an appearance and with components of the flashlight possible to fall off owing to mutual bumping with keys on the chain.

### SUMMARY OF THE INVENTION

This invention has been devised to offer a flashlight movably used for shining various locations or placed at a location stationary for shining that location only, and also used as a decoration possible to be worn and carried around or hung on a wall.

The feature of the invention is a base, a lamp unit arranged on the base and consisting of an electric circuit board and a plurality of LED and a switch. Two terminals are provided under the lower surface of the circuit board for connecting with those of a 9V battery. Further a cover is provided to close over the base and the lamp unit.

### BRIEF DESCRIPTION OF DRAWINGS

This invention will be better understood by referring to the accompanying drawings, wherein:

FIG. 1 is an exploded perspective view of a flashlight in the present invention;

FIG. 2 is a perspective view of the flashlight in the present invention;

FIG. 3 is a cross-sectional view of the flashlight in the present invention;

FIG. 4 is a perspective view of the flashlight under a used condition in the present invention;

FIG. 5 is a perspective view of the flashlight used as a decoration in the present invention; and,

FIG. 6 is a perspective view of the flashlight with a transparent cover in the present invention.

### DETAILED DESCRIPTION OF THE PREFERRED EMBODIMENT

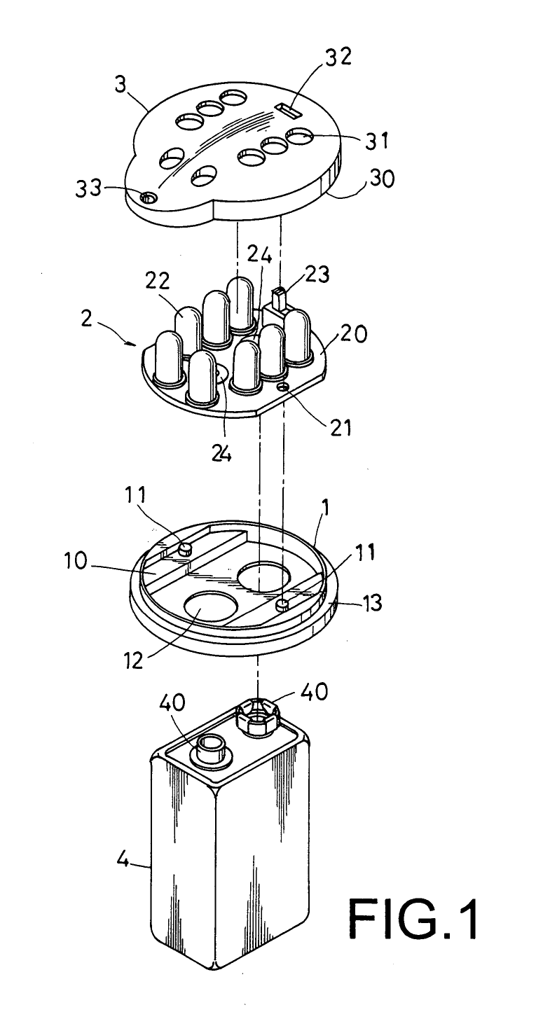

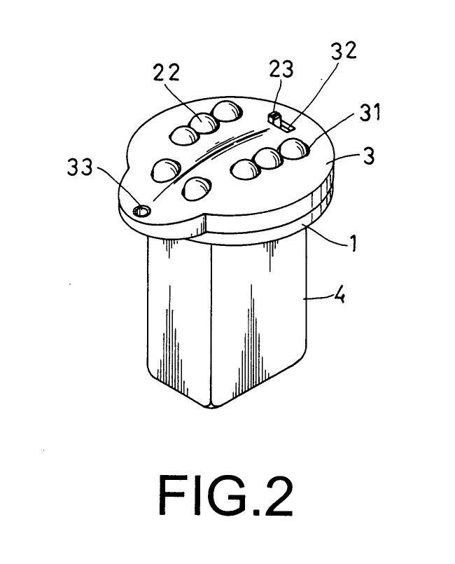

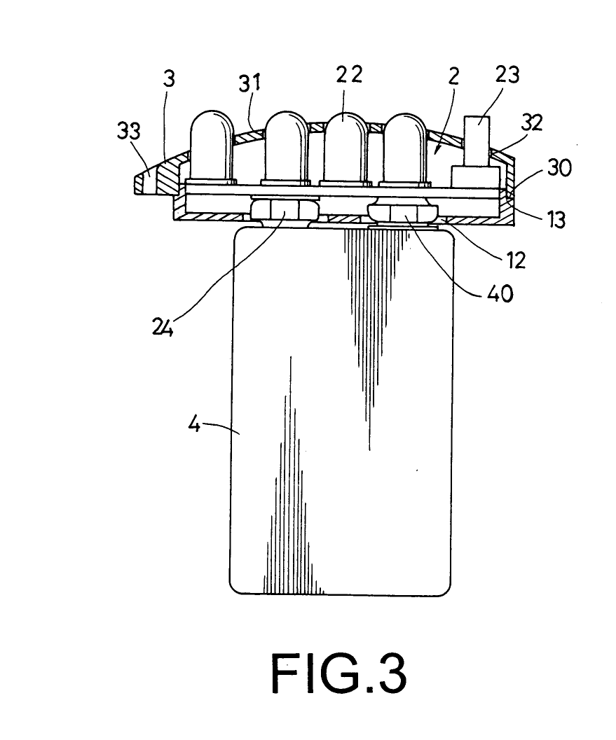

A preferred embodiment of a flashlight in the present invention, as shown in FIGS. 1, 2 and 3, includes a base 1, a lamp unit 2, a cover 3 and a 9V battery.

The base 1 is preferably circular, having a recess 10 formed in an upper side, a projection 11 respectively at two opposite sides in the recess 10, plural through holes 12 formed properly in the center portion, and an annular step 13 around an outer periphery.

The lamp unit 2 is arranged 1 in the recess 10 on the base 1, consisting of an electric circuit board 20 and a plurality of LED 22 and a switch 23. The electric circuit board 20 has two opposite holes 21 to correspond with the two projections 11 of the base 1. The LED 22 are fixed on the circuit board 20, and plural terminals 24 are provided under the lower surface of the circuit board 20 to correspond with the through holes 12 of the base 1.

The cover 3 closes on the base 1 and the lamp unit 2, provided with a lower annual edge 30 to fit securely on the annular step 13 of the base 1 and plural lamp holes 31 to respectively correspond with the LED 22, a slot in a rear portion for the switch 23 to protrude out thereof, and a hang hole 33 formed in the front portion for hanging the flashlight on something.

The 9V battery is to be affixed with the lower side of the base 1, having two terminals 40 on the upper surface to contact with the terminals 24 of the lamp unit 2 to supply the LED with electricity.

In assembling, as shown in FIGS. 1, 2 and 3, firstly, the electric circuit board 20 is placed in the recess 10 of the base 1, with the holes 21 respectively fitted in by the projections 11 of the base, and with the terminals 24 of the circuit board 20 extending out of the through holes 12 of the base 1. Then the cover 3 is placed to cover on the base 1, with the LED respectively facing and protruding up a little through the lamp holes 31 of the cover 3, and with the switch 23 protruding out of the holes of the cover 3 for manually handled. Lastly, the 9V battery 4 is combined with the base 1, with the terminals 40 respectively made to contact with the terminals 24 of the lamp unit 2, finishing assembly of the flashlight in the invention.

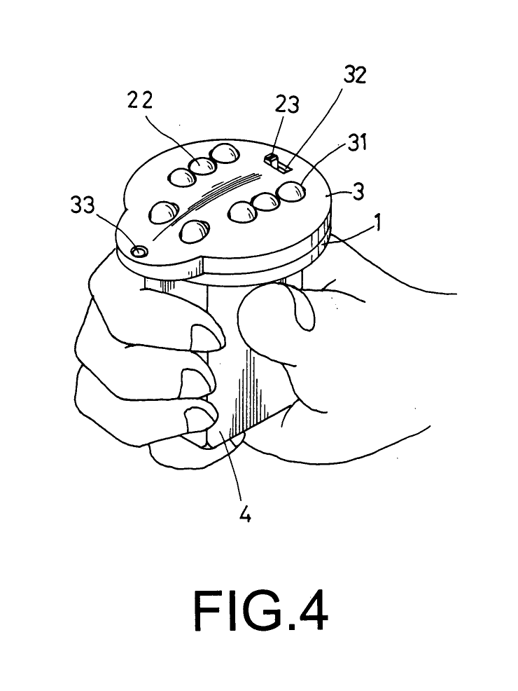

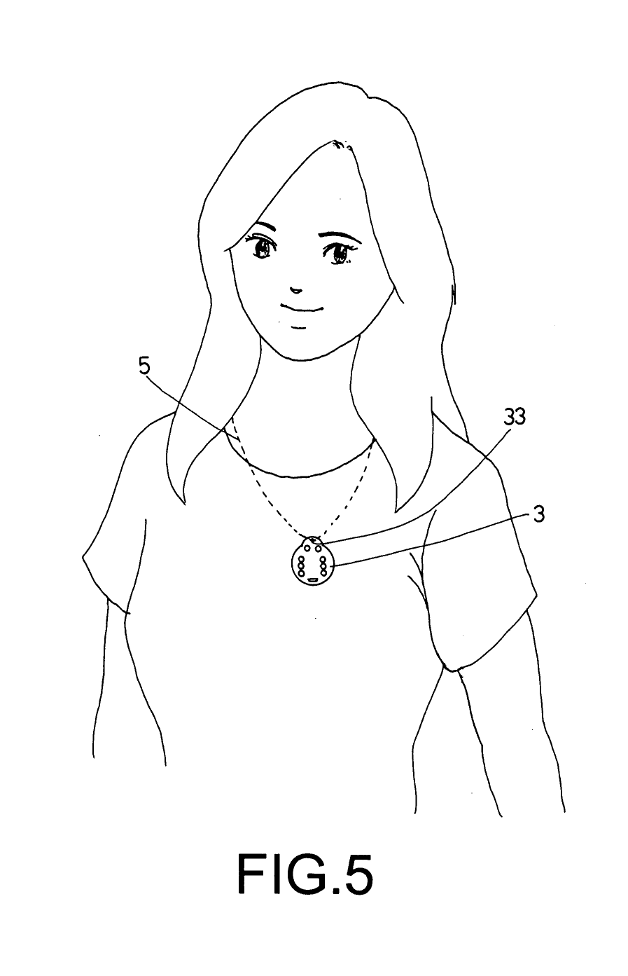

In using, as shown in FIGS. 4, 5 and 6, a user manually holds the 9V battery as shown in FIG. 4, and then turns on the switch 23, and can move the flashlight to shine a place wanted or places the flashlight any location stationary to shine it only. When the flashlight is not used for shining, but for decoration, the battery 4 is to be taken off the base 1, and a necklace 5 or a neck chain can be used to string through the hang hole 33 of the cover 3 to wear it as a decoration as shown in FIG. 5.

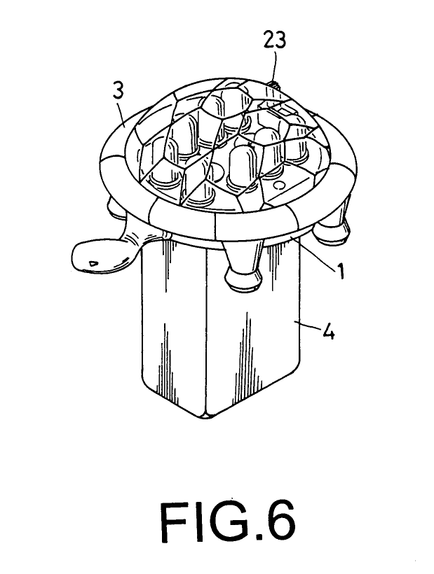

Further, the cover 3 can be made transparent as shown in FIG. 6 for the light of the LED 22 to shine through. In addition, the cover 3 may be made to have an intriguing shape such as any insects, animals or fruits, upgrading the value as a commodity.

The flashlight according to the invention has the following advantages.

1. Its assembly is quite easy and simple.

2. Its use is convenient: contacting connection of the terminals of the battery 4 with the terminals of the lamp unit 3 can permit the flashlight turned on and off for shining.

3. It can be held with a hand of a user gripping the battery 4 to shine any location or be placed at any location stationary to shine that location only, and also possible to be carried out and be used any time.

4. It can be strung through the hang hole of the base with a necklace or the like to wear it or hang it on a wall as a decoration.

5. The cover can be made into an intriguing shape such as any insects or animals to use it as a decoration while it is not used as a flashlight.

6. It has several functions, and the cover made with different shapes to arouse curiosity, beefing up its quality and the value as a commodity.

While the preferred embodiment of the invention has been described above, it will be recognized and understood that various modifications may be made therein and the appended claims are intended to cover all such modifications that may fall within the spirit and scope of the invention.

What is claimed is:

1. A flashlight comprising:
a base provided with a through hole at least;
a lamp unit arranged on said base, said lamp unit consisting of an electric circuit board and a plurality of LED and a switch fixed on said electric circuit board, said electric circuit board having two terminals provided under a lower surface of said electric circuit board;
a lamp unit closing on said base and said lamp unit; and,
a user combining a 9V battery with said base and making two terminals of said battery contact respectively with said terminals of said lamp unit, the user then turning on said switch to lit up said LED and possible to move said flashlight to any place for shining by griping said 9V battery.

2. The flashlight as claimed in claim 1, wherein said base further has a recess, and a plurality of projections in said recess at opposite sides, and an annular step formed at an outer periphery.

3. The flashlight as claimed in claim 1, wherein said electric circuit board of said lamp unit has a hole respectively at opposite sides for said projections of said base to fit therein.

4. The flashlight as claimed in claim 1, wherein said cover further has a hang hole for a hanging chain to pass through to enable said flashlight worn as a decoration.

5. The flashlight as claimed in claim 1, wherein said cover has a lower annular edge to rest securely on said annular step of said base, a plurality of lamp holes to correspond respectively with said LED of said lamp unit, and a slot for said switch of said lamp unit to protrude out thereof.
